(19) United States
(12) Patent Application Publication
(10) Pub. No.: US 2010/0252769 A1
(43) Pub. Date: Oct. 7, 2010

(54) PLUNGER FOR A SOLENOID VALVE AND A METHOD FOR LABELING PLUNGERS FOR SOLENOID VALVES

(76) Inventors: Ronny Goepfert, Oederan (DE); Sezgin Acar, Ludwigsburg (DE); Isabelle Rey, Rettenberg (DE); Thorsten Schelldorf, Sulzberg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/740,560

(22) PCT Filed: Sep. 22, 2008
(86) PCT No.: PCT/EP2008/062614

§ 371 Date: Jun. 11, 2010

(30) Foreign Application Priority Data
Oct. 29, 2007 (DE) 10 2007 051 550.4

(51) Int. Cl. F16K 13/00; B26D 3/00

(52) U.S. Cl. 251/324; 83/13

(57) ABSTRACT

The invention relates to a plunger for a solenoid valve having a plunger shaft, a closure element, and a sealing element, and a method for labeling plungers for solenoid valves. According to the invention, at least one permanent mark is applied by means of machining, allowing the association of the corresponding plunger to a specific type of plunger from a plurality of various types of plungers.

### BACKGROUND OF THE INVENTION

The invention relates to a plunger for a solenoid valve as generically defined by the preamble to independent claim 1 and to a method for labeling plungers for solenoid valves.

For conventional solenoid valves, used in particular for hydraulic assemblies that are used for instance in an anti-lock brake system (ABS) or a traction control system (TC system) or an electronic stability program system (ESP system), plastic plungers or plungers of metal, preferably made from steel, are used. The metal plungers are used for solenoid valves of which more stringent demands in terms of geometry are made. One such metal plunger is shown in FIG. 1. As can be seen from FIG. 1, the conventional plunger 1 of metal includes a plunger shaft 2 with a contact face 2.1, a closing element 3, and a sealing element 4. With the contact face 2.1, the plunger 1 rests on a magnet armature, not shown, of the solenoid valve; this armature moves the plunger 1 as a function of a generated magnetic force, and for performing a sealing function, the sealing element 4 plunges into a corresponding valve sealing seat, not shown, disposed in a so-called valve body, also not shown.

In the conventional solenoid valves, depending on the use of the solenoid valve, various working air gaps or remanent air gaps may be necessary, so that for the particular use, the positions of the individual components of the solenoid valve can shift during assembly. Certain components are therefore adapted dimensionally. To attain the least possible changes and to affect the known influencing factors for the solenoid valves as little as possible, the components are not designed as fundamentally novel but instead are made as identical as possible. Since as a rule only slight changes in dimension occur, which are in the range of below 0.2 mm, it is difficult during manufacture to distinguish the essentially identically embodied components from one another. For instance, the length of the plunger can be shortened in order to compensate for a reduction in the remanent air gap and an attendant different positioning of a valve body having the valve sealing seat.

### DISCLOSURE OF THE INVENTION

The solenoid valve of the invention having the characteristics of independent claim 1 has the advantage over the prior art that by means of a metal-cutting machining operation, at least one permanent marking is made in the plunger shaft, which makes it possible to associate the corresponding plunger with a certain plunger type from among a plurality of various plunger types.

The method of the invention for labeling plungers for solenoid valves, having the characteristics of independent claim 8, has the advantage that a corresponding plunger is associated with a certain plunger type from among a plurality of various plunger types, and by means of a metal-cutting machining operation at least one permanent marking is made in the corresponding plunger shaft, which marking represents the predetermined plunger type with which the corresponding plunger is associated.

Both the plunger and the method of the invention advantageously make it possible, in the manufacture of an associated solenoid valve, to distinguish among various essentially structurally identical plungers, which differ only slightly, for instance in their length. By means of the permanent marking, the magnetic and hydraulic properties of the plunger are advantageously not adversely changed.

By means of the provisions and refinements recited in the dependent claims, advantageous improvements to the plunger defined by independent claim 1 and to the method defined by independent claim 8 are possible.

It is especially advantageous that the permanent marking is made as a centering bore in the contact face of the plunger shaft. For example, the centering bore is embodied such that a bore depth and a bore diameter have a predetermined ratio of at least 2:1. During manufacture, the centering bore can advantageously be scanned and detected automatically by a camera system, with the camera system detecting and evaluating a shadow of the centering bore. The given ratio of the bore depth to the bore diameter of at least 2:1 ensures that a large enough shadow to be detected and evaluated by the camera system is created. A residue of material, which in a turning process may remain in the center of the plane contact face, is removed, so that in the constructed state, a plane contact of the plunger with a corresponding armature is advantageously possible. As a function of the association of the corresponding plunger with a certain plunger type, the centering bores) can be embodied with variable bore depths and/or variable bore diameters. Therefore, further plunger types can advantageously be distinguished from one another from the various bore depths and bore diameters.

In a feature of the plunger of the invention, alternatively or additionally, the permanent marking can be made in the plunger shaft in the form of at least one encompassing turned groove. In this embodiment, the number of turned grooves is variable as a function of the association of the corresponding plunger with a certain plunger type. Therefore, further plunger types can be distinguished from one another from the number and disposition of the turned grooves.

The at least one permanent marking for detecting the associated plunger type can alternatively to a camera system also be evaluated and detected by a mechanical scanning system, which for instance has at least one feeler or by a contactless electronic scanning system that for instance includes a laser.

Advantageous embodiments of the invention that are described below, along with the conventional exemplary embodiments described above for the sake of better comprehension of the invention, are shown in the drawings. In the drawings, identical reference numerals identify components and elements that perform the same or analogous functions.

### BRIEF DESCRIPTION OF THE DRAWINGS

FIG. 1 shows a schematic side view of a conventional plunger for a solenoid valve.

FIG. 2 shows a schematic side view of a plunger of the invention for a solenoid valve.

FIG. 3 shows a schematic view of a detail III of FIG. 2.

### EMBODIMENTS OF THE INVENTION

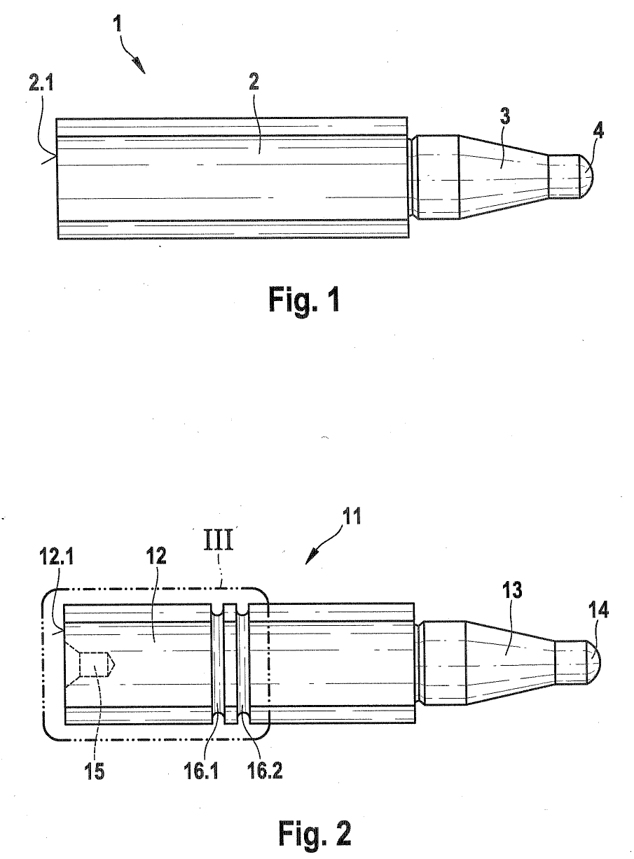

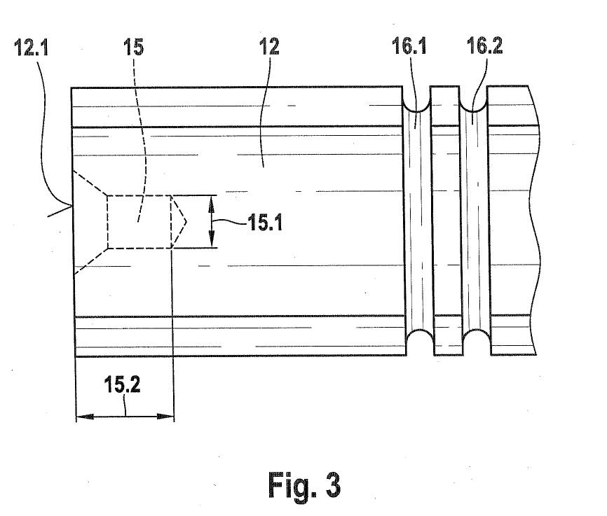

As can be seen in FIGS. 2 and 3, a plunger 11 of metal, preferably of steel, according to the invention for a solenoid valve, analogously to the conventional plunger 1 of FIG. 1, includes a plunger shaft 12 with a contact face 12.1 and a closing element 13 as a transition between the plunger shaft 12 and a sealing element 14. Unlike the conventional plunger 1 of FIG. 1, in the plunger shaft 12 of the invention at least one permanent marking 15, 16.1, 16.2 is made by means of a metal-cutting machining operation, which makes it possible to associate the corresponding plunger 11 with a certain plunger type from among a plurality of different plunger types.

As can further be seen from FIGS. 2 and 3, a first permanent marking is embodied as a centering bore 15, which is made in the contact face 12.1 of the plunger shaft 12 with a certain bore depth 15.2 and a certain bore diameter 15.1. In the exemplary embodiment shown, the centering bore 15 is embodied such that the bore depth 15.2 and the bore diameter 15.1 have a predetermined ratio of at least 2:1. During manufacture, the centering bore 15 is automatically scanned and detected by a camera system, not shown, which detects and evaluates a shadow of the centering bore. The given ratio of the bore depth 15.2 to the bore diameter 15.1 of at least 2:1 ensures that a large enough shadow to be reliably detected and evaluated by the camera system is created. Alternatively to the camera detection, the centering bores can for instance be scanned and detected mechanically by a feeler, not shown, or in contactless fashion by a laser, not shown.

As second permanent markings, the exemplary embodiment shown of the plunger of the invention has for instance two encompassing turned grooves 16.1, 16.2 in the plunger shaft 12; the number of turned grooves 16.1, 16.2 is varied as a function of the association of the corresponding plunger 11 with a certain plunger type. During the manufacture of a solenoid valve, the turned grooves 16.1, 16.2 made in the plunger shaft can also be scanned and detected by a camera system, or a mechanical scanning system, or a contactless electronic scanning system.

In the method of the invention for labeling plungers 11 for solenoid valves, a corresponding plunger 11 is associated, for instance as a function of its length, with a certain plunger type from among a plurality of different plunger types. Depending on the association with the certain plunger type, the at least one permanent marking 15, 16.1, 16.2 is made in the corresponding plunger shaft 12 by means of a metal-cutting machining operation. Thus the marking 15, 16.1, 16.2 made represents the predetermined plunger type with which the corresponding plunger 11 is associated. In the exemplary embodiment shown, the first permanent marking is made in the form of a centering bore 15 in the contact face 12.1 of the plunger shaft 12; as a function of the association of the corresponding plunger 11 with a certain plunger type, the centering bores 15 are made with variable bore depths 15.2 and/or variable bore diameters 15.1. The second permanent markings are made in the form of encompassing turned grooves 16.1, 16.2 in the plunger shaft 12, and the number of turned grooves 16.1, 16.2 is varied as a function of the association of the corresponding plunger 11 with a certain plunger type.

In an alternative embodiment, not shown, of the plunger 11 of the invention, only the centering bore 15 may be used as a permanent marking in order to distinguish various plunger types in the manufacture of the solenoid valves. In addition, in a further embodiment, not shown, of the plunger of the invention, only the turned grooves 16.1, 16.2 are used as a permanent marking, for distinguishing various plunger types in the manufacture of the solenoid valves.

The plunger and the method of the invention both advantageously make is possible, in the manufacture of solenoid valves, to distinguish reliably among plungers that for instance based on their length are associated with various plunger types. The permanent marking made by metal-cutting machining makes a reliable distinction possible even if the plungers of the various plunger types are embodied essentially identically, and the dimensional differences between plungers of the various plunger types are less than 0.2 mm.

1-10. (canceled)

11. A plunger for a solenoid valve, having a plunger shaft, a closing element, and a sealing element, wherein by means of a metal-cutting machining operation, at least one permanent marking is made in the plunger shaft, which marking makes it possible to associate a corresponding plunger having the marking with a certain plunger type from among a plurality of various plunger types.

12. The plunger as defined by claim 11, wherein the permanent marking is made as a centering bore in a contact face of the plunger shaft.

13. The plunger as defined by claim 11, wherein the centering bore is embodied such that a bore depth and a bore diameter have a predetermined ratio of at least 2:1.

14. The plunger as defined by claim 12, wherein the centering bore is embodied such that a bore depth and a bore diameter have a predetermined ratio of at least 2:1.

15. The plunger as defined by claim 11, wherein as a function of the association of the corresponding plunger with a certain plunger type, the centering bores can be embodied with variable bore depths and/or variable bore diameters.

16. The plunger as defined by claim 12, wherein as a function of the association of the corresponding plunger with a certain plunger type, the centering bores can be embodied with variable bore depths and/or variable bore diameters.

17. The plunger as defined by claim 13, wherein as a function of the association of the corresponding plunger with a certain plunger type, the centering bores can be embodied with variable bore depths and/or variable bore diameters.

18. The plunger as defined by claim 11, wherein the permanent marking is made in the plunger shaft in the form of at least one encompassing turned groove.

19. The plunger as defined by claim 12, wherein the permanent marking is made in the plunger shaft in the form of at least one encompassing turned groove.

20. The plunger as defined by claim 13, wherein the permanent marking is made in the plunger shaft in the form of at least one encompassing turned groove.

21. The plunger as defined by claim 15, wherein the permanent marking is made in the plunger shaft in the form of at least one encompassing turned groove.

22. The plunger as defined by claim 18, wherein a number of turned grooves is variable as a function of the association of the corresponding plunger with a certain plunger type.

23. The plunger as defined by claim 19, wherein a number of turned grooves is variable as a function of the association of the corresponding plunger with a certain plunger type.

24. The plunger as defined by claim 20, wherein a number of turned grooves is variable as a function of the association of the corresponding plunger with a certain plunger type.

25. The plunger as defined by claim 21, wherein a number of turned grooves is variable as a function of the association of the corresponding plunger with a certain plunger type.

26. The plunger as defined by claim 11, wherein the at least one permanent marking can be evaluated, for recognizing an associated plunger type, by a camera system or a mechanical scanning system or a contactless electronic scanning system.

27. A method for identifying plungers for solenoid valves, comprising the steps of
associating a corresponding plunger with a certain plunger type from among a plurality of various plunger types, and
by means of a metal-cutting machining operation making at least one permanent marking in a corresponding plunger shaft, which marking represents the certain plunger type with which the corresponding plunger is associated.

28. The method as defined by claim 27, wherein the permanent marking is made as a centering bore in a contact face of the plunger shaft, and as a function of the associating the corresponding plunger with a certain plunger type, the centering bore is embodied with variable bore depths and/or variable bore diameters.

29. The method as defined by claim 27, wherein the permanent marking is made in the plunger shaft in the form of at least one encompassing turned groove, and a number of turned grooves is varied as a function of the associating the corresponding plunger with a certain plunger type.

30. The method as defined by claim 28, wherein the permanent marking is made in the plunger shaft in the form of at least one encompassing turned groove, and a number of turned grooves is varied as a function of the associating the corresponding plunger with a certain plunger type.
